(19) United States
(12) Patent Application Publication
(10) Pub. No.: US 2010/0273903 A1
(43) Pub. Date: Oct. 28, 2010

(54) HEAT-FOAMABLE SHEET, PRODUCING METHOD THEREFOR, AND FOAM FILLING MEMBER

(75) Inventors: Yoshiaki Mitsuoka, Osaka (JP); Takeo Nishioka, Osaka (JP); Yasuharu Imamura, Osaka (JP); Osamu Degawa, Osaka (JP); Kazumasa Asano, Osaka (JP); Takehiro Ui, Osaka (JP); Mitsuo Matsumoto, Osaka (JP); Takahiro Fujii, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/735,238

(22) PCT Filed: Dec. 26, 2008
(86) PCT No.: PCT/JP2008/073830

§ 371 Date: Jun. 24, 2010

(30) Foreign Application Priority Data
Jan. 16, 2008 (JP) 2008-007232

(51) Int. Cl. C08J 9/00; B29C 47/00; B29C 47/58

(52) U.S. Cl. 521/79; 264/211; 264/146

(57) ABSTRACT

The present invention provides a heat-foamable sheet that foams uniformly and omnidirectionally, a method for producing the heat-foamable sheet, and a foam filling member including the heat-foamable sheet. A heat-foamable sheet having a horizontal to vertical ratio of 1.5 or less when heated at 160° C. for 20 minutes is obtained by a method for producing a heat-foamable sheet including: an extrusion step of extruding a heat-foamable material containing a polymer and a foaming agent into an isotropy-containing shape including an isotropic portion of a generally arc shape; and a sheet-forming step of forming the heat-foamable material that is extruded in the extrusion step into a sheet shape.

### TECHNICAL FIELD

The present invention relates to a heat-foamable sheet, a producing method therefor, and a foam filling member. In particular, the present invention relates to a heat-foamable sheet that is suitable for filling the inner space of a hollow member, a producing method therefor, and a foam filling member.

### BACKGROUND ART

Heretofore, it has been known that a hollow member formed as a closed cross section such as an automotive pillar is filled with a foam in order to prevent vibration or noise of an engine, or wind noise from being propagated into the car interior.

Such a foam can be obtained, for example, by heating and foaming a foam sheet that is molded into a sheet by extrusion molding or calendering and then processed (for example, see Patent Document 1 below).

As such a foam sheet, there has been proposed that a heat-foamable sheet that extends to one direction when heated at a temperature of 100 to 130° C., and has an extension ratio in that extension direction of 5 to 50% is used as the foam filling member to easily fill a protruding space (for example, see Patent Document 2 below).

### Patent Document 1: Japanese Unexamined Patent Publication No. 2006-151333

### Patent Document 2: Japanese Unexamined Patent Publication No. 2007-76169

### DISCLOSURE OF THE INVENTION

### Problem to be Solved by the Invention

However, as is noted in Patent Document 2 above, while there is a need for filling a protruding space by one directional foaming, there is also a case where there is a need for filling a space uniformly by omnidirectional foaming.

However, in a heat-foamable sheet molded by general extrusion molding such as the one described in Patent Document 1 above, when the sheet is heated and foamed, the foaming amount differs depending on portions of the heat-foamable sheet (e.g., a widthwise center portion and both widthwise end portions in a direction perpendicular to the extrusion direction) due to the differences in the polymer flow in the die, and therefore it is difficult to ensure uniform foaming.

Furthermore, in calendering, when the sheet is taken from the calender roll, the sheet is stretched to some extent in the direction of which the sheet is taken. Thus, when the heat-foamable sheet is heated and foamed, the sheet shrinks in the stretched direction, and expands in the direction perpendicular to the stretched direction. As a result, naturally, ensuring uniform foaming is difficult.

Thus, an object of the present invention is to provide a heat-foamable sheet that foams uniformly and omnidirectionally, a method for producing the heat-foamable sheet, and further, a foam filling member including the heat-foamable sheet.

### Means for Solving the Problem

To achieve the above object, the heat-foamable sheet of the present invention is a heat-foamable sheet molded by subjecting a heat-foamable material containing a polymer and a foaming agent to extrusion molding, wherein the heat-foamable sheet has a horizontal to vertical ratio of 1.5 or less when heated at 160° C. for 20 minutes.

A heat-foamable sheet of the present invention has isotropic characteristics.

A method for producing a heat-foamable sheet of the present invention includes: an extrusion step of extruding a heat-foamable material containing a polymer and a foaming agent into an isotropy-containing shape including an isotropic portion of generally an arc shape; and a sheet-forming step of forming the heat-foamable material that is extruded in the extrusion step into a sheet shape.

It is preferable that, in the method for producing a heat-foamable sheet of the present invention, in the extrusion step, a cylindrical molded product is obtained by extruding the heat-foamable material into a cylindrical shape with an extruder equipped with a die having a discharge opening of a hoop shape; and in the sheet-forming step, a sheet-shaped molded product is obtained by continuously cutting the cylindrical molded product in the extrusion direction with a cutter, wherein the cutter is disposed at a downstream side of the discharge opening in the extrusion direction so as to overlap with a portion of the discharge opening when the cutter is projected in the extrusion direction.

It is preferable that, in the method for producing a heat-foamable sheet of the present invention, the extrusion step and the sheet-forming step are simultaneously performed by extruding the heat-foamable material with an extruder equipped with a die having a discharge opening having an end-portion-including shape including a generally arc portion.

It is preferable that, in the method for producing a heat-foamable sheet of the present invention, the heat-foamable material that is formed into a sheet shape is transported by a conveyer having a speed that is substantially the same as the extrusion speed in the extrusion step.

A foam filling member of the present invention includes the above-described heat-foamable sheet, and a fixing member that is attached to the heat-foamable sheet and is fixable to an inner space of a hollow member.

### EFFECT OF THE INVENTION

The heat-foamable sheet of the present invention has a horizontal to vertical ratio of 1.5 or less when heated at 160° C. for 20 minutes, and therefore a change in the horizontal to vertical ratio is decreased even when heated and foamed. Therefore, in the foam filling member including the heat-foamable sheet of the present invention, by attaching a fixing member to the inner space and heating and foaming the heat-foamable sheet, uniform and omnidirectional foaming of the heat-foamable sheet can be achieved. As a result, a space can be filled uniformly. Furthermore, according to the method for producing the heat-foamable sheet of the present invention, the heat-foamable sheet of the present invention can be produced easily and with good production efficiency.

### BRIEF DESCRIPTION OF THE DRAWINGS

FIG. 1 is a schematic diagram illustrating the configuration of an embodiment of an extruder for molding a heat-foamable sheet of the present invention.

FIG. 2 shows plan views of dies for molding a heat-foamable sheet of the present invention viewed in the extrusion direction: (a) illustrates a die having a discharge opening of a hoop shape; (b) illustrates a die having a discharge opening of a partially cutaway hoop shape (generally C-shaped); and (c) illustrates a die having a discharge opening of a horseshoe shape (generally U-shaped).

FIG. 3 shows process drawings of an embodiment of a method for filling an inner space using the foam filling member of the present invention: (a) illustrates a step of preparing a foam filling member by attaching a clip to a heat-foamable sheet, and placing the member in a pillar; and (b) illustrates a step of filling an inner space with a foam by heating and foaming the foam filling member.

FIG. 4 shows a schematic diagram illustrating the configuration of an extruder for molding a heat-foamable sheet of Comparative Example 1.

FIG. 5 is a schematic diagram illustrating the configuration of a calender roll apparatus for molding a heat-foamable sheet of Comparative Example 2.

### EMBODIMENT OF THE INVENTION

The heat-foamable sheet of the present invention is formed by molding a heat-foamable material that foams by heat into a sheet by extrusion molding.

The heat-foamable material contains at least a polymer as a main component, and a foaming agent for foaming the polymer.

Although there is no particular limitation on the polymer, examples thereof include resins such as an ethylene-vinyl acetate copolymer, polyethylene, polypropylene, polyester, polyvinyl butyral, polyvinyl chloride, polyamide, and polyketone; and rubbers such as styrene-butadiene rubber (SBR), and polybutadiene rubber (BR).

Preferably, the ethylene-vinyl acetate copolymer is used. By using the ethylene-vinyl acetate copolymer, a high foaming ratio can be achieved.

Among these polymers, a polymer having a melting point in the range of 60 to 120° C., or 80 to 100° C. is preferably selected. When the melting point is below 60° C., the polymer itself develops viscosity, so that the handling thereof occasionally becomes difficult even at a room temperature. When the melting point exceeds 120° C., a processing temperature needs to be increased and the foaming agent might be decomposed during processing. The melting point is measured by using a DSC (differential scanning calorimeter).

These polymers may be used singly, or may be used in combination of two or more.

Examples of the foaming agent include an inorganic foaming agent and an organic foaming agent. Examples of the inorganic foaming agent include ammonium carbonate, ammonium hydrogen carbonate, sodium hydrogen carbonate, ammonium nitrite, sodium borohydride, and azides.

Examples of the organic foaming agent include azo compounds such as azodicarbonamide, barium azodicarboxylate, azobisisobutyronitrile, and azodicarboxylic acid amide; nitroso compounds such as N,N′-dinitrosopentamethylenetetramine, N,N′-dimethyl-N,N′-dinitrosoterephthalamide, and trinitrotrimethyltriamine; hydrazide compounds such as 4,4′-oxybis(benzenesulfonylhydrazide), p-toluenesulfonylhydrazide, diphenylsulfon-3,3′-disulfonylhydrazide, and allylbis(sulfonylhydrazide); semicarbazide compounds such as p-toluoylenesulfonylsemicarbazide and 4,4′-oxybis(benzenesulfonylsemicarbazide); alkane fluorides such as trichloromonofluoromethane and dichloromonofluoromethane; and a triazole compound such as 5-morpholyl-1,2,3,4-thiatriazole.

Among these foaming agents, a foaming agent is selected appropriately in accordance with the composition, i.e., a foaming agent that is decomposed at a temperature of the melting point of the polymer or more to generate gas, and that barely foams during the molding of the heat-foamable material, which will be described later, is selected. Preferably, a foaming agent which foams (decomposes) at a temperature of 140 to 180° C. is used. More specifically, 4,4′-oxybis(benzenesulfonylhydrazide) is used.

Among these foaming agents, one, or two or more can be selected appropriately for use. The mixing ratio of the foaming agent is not particularly limited. For example, the mixing ratio of the foaming agent relative to 100 parts by weight of the polymer is 5 to 50 parts by weight, or preferably 10 to 30 parts by weight.

Preferably, the mixing amount of the foaming agent is in a range that provides a foaming ratio of about 5 to 25, or preferably about 10 to 20, and substantially allows the formation of closed-cell foam when the heat-foamable sheet is foamed. When the mixing amount of the foaming agent is excessively small, the heat-foamable sheet does not sufficiently foam. When the mixing amount of the foaming agent is excessively large, a clearance due to resin sag of a foam obtained by foaming is formed. In either case, the filling properties are degraded.

To efficiently foam, crosslink, and cure the polymer, for example, a crosslinking agent, a foaming auxiliary agent, and the like are further mixed appropriately in the heat-foamable material.

The crosslinking agent is not particularly limited. An example of the crosslinking agent is a radical generator which is decomposed by heating to generate free radicals and causes intermolecular or intramolecular crosslinkage to be formed. More specifically, examples thereof are organic peroxides such as dicumyl peroxide, 1,1-ditertiarybutylperoxy-3,3,5-trimethylcyclohexane, 2,5-dimethyl-2,5-ditertiarybutylperoxyhexane, 2,5-dimethyl-2,5-ditertiarybutylperoxyhexyne, 1,3-bis(t-butylperoxyisopropyl)benzene, tertiarybutylperoxyketone, and tertiarybutylperoxybenzoate.

When the polymer is vulcanizable, a vulcanizer can be used as the crosslinking agent. Such a vulcanizer is not particularly limited. Examples of the vulcanizer include sulfur, sulfur compounds, selenium, magnesium oxides, lead monoxide, zinc oxides, polyamines, oximes, nitroso compounds, resins, and ammonium salts.

Among these crosslinking agents, one, or two or more can be selected appropriately for use. The mixing ratio of the cross-linking agent is, for example, 0.1 to 10 parts by weight, or preferably 0.5 to 7 parts by weight relative to 100 parts by weight of the polymer, without particular limitation.

When the vulcanizer is used, a vulcanization accelerator can be used in combination. Examples of the vulcanization accelerator include dithiocarbamic acids, thiazoles, guanidines, sulfene amides, thiurams, xanthic acids, aldehyde ammonias, aldehyde amines, and thioureas. One, or two or more of these vulcanization accelerators can be selected appropriately for use. The mixing ratio of the vulcanization accelerator relative to 100 parts by weight of the polymer is 0.1 to 5 parts by weight.

Instead of the vulcanization accelerator, a known vulcanization retardant such as an organic acid and amines can also be mixed appropriately for the purpose of adjusting moldability.

As the foaming auxiliary agent, a known foaming auxiliary agent may be appropriately selected according to the type of the foaming agent without particular limitation, and specific examples thereof include a urea compound containing urea as a main component; a metal oxide such as zinc oxide and lead oxide; a higher fatty acid such as salicylic acid and stearic acid, or a metal salt of the higher fatty acid. Preferably, a metal salt of the higher fatty acid is used.

One, or two or more of these foaming auxiliary agents may be appropriately selected for use. The mixing ratio of the foaming auxiliary agent is, for example, 1 to 20 parts by weight, or preferably 5 to 10 parts by weight relative to 100 parts by weight of the polymer, without particular limitation.

A known additive may be appropriately mixed in the heat-foamable material depending on the purpose and application to the extent that does not affect the physical properties of the foam to be obtained. Examples of the additive are a stabilizer, a reinforcing agent, a filler, a softener, and a lubricant. Furthermore, as necessary, additives such as a plasticizer, an age resister, an antioxidant, a pigment, a coloring agent, an antifungal agent, and a fire retardant may also be mixed therein.

The heat-foamable material is prepared, for example, by mixing the above-described components at the above-described mixing ratio, and kneading the mixture by using, for example, a mixing roll, or a pressure kneader. The method of kneading the heat-foamable material is not particularly limited, and for example, a known kneader may be appropriately used.

The heat-foamable material is preferably prepared such that its viscosity is in the range from 100 to 10000 Pa·s (100° C.).

The heat-foamable sheet can be obtained by molding the heat-foamable material thus prepared as described above into a sheet by extrusion molding.

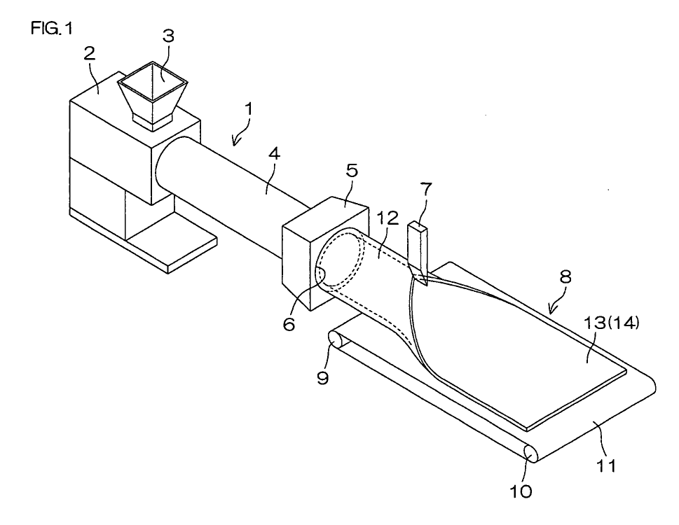

FIG. 1 is a schematic diagram illustrating the configuration of an embodiment of an extruder for molding a heat-foamable sheet of the present invention.

Next, with reference to FIG. 1, a description will be given of a method for molding a heat-foamable sheet 14 by extrusion molding using an extruder 1.

In FIG. 1, the extruder 1 has a power unit 2, a hopper 3 disposed above the power unit 2, a cylinder 4 disposed at a side of the power unit 2, and a die 5 disposed at a distal end portion of the cylinder 4.

The power unit 2 generally has, although not shown, a speed reducer, a motor, and the like. In the power unit 2, the rotation speed of the motor is controlled by the speed reducer, and a driving force is given to a screw to be described later.

The hopper 3 has a funnel-like shape, and the heat-foamable material is introduced into the hopper 3.

The cylinder 4 has a cylindrical shape extending in a horizontal direction, and has a screw therein, although not shown. The screw may be single (uniaxial), or double (biaxial).

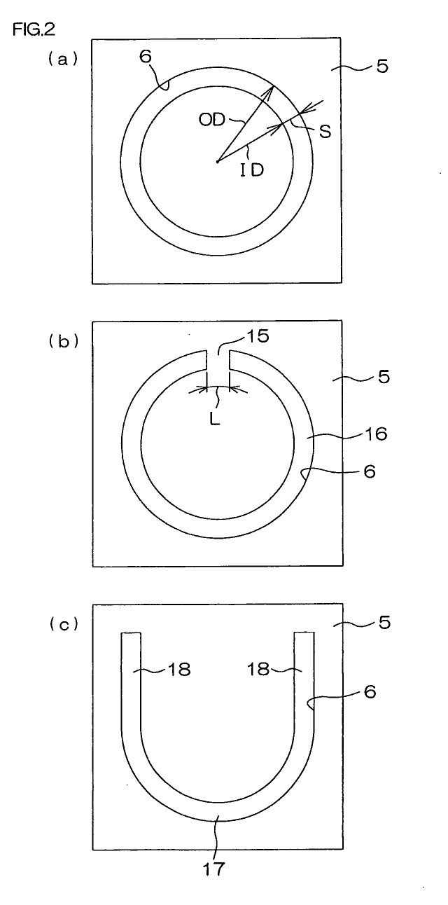

The die 5 is provided at a downstream end portion of the cylinder 4 in the extrusion direction. As shown in FIG. 2(a), the die 5 has a discharge opening 6 formed so as to form the heat-foamable material into a predetermined shape. The discharge opening 6 is formed into a hoop shape (ring shape). To be specific, the discharge opening 6 is formed into a hoop shape such that the inner diameter ID of the discharge opening 6 is, for example, 30 to 150 mm; the outer diameter OD of the discharge opening 6 is, for example, 31 to 155 mm; and the space (the clearance between the inner diameter and the outer diameter) S is, for example, 1 to 5 mm.

At a downstream side in the extrusion direction of the extruder 1 (in the following, simply referred to as a downstream side), to be specific, at a downstream side of the die 5, a cutter 7 and a conveyer 8 are provided.

The cutting edge of the cutter 7 is disposed at a downstream side of the discharge opening 6 to overlap with the discharge opening 6 when projected in the extrusion direction, so as to intersect a portion of the discharge opening 6 in the direction of the diameter of the discharge opening 6. To be specific, the cutting edge of the cutter 7 is disposed to overlap with any one of an upper end portion, a lower end portion, and a lateral end portion of the discharge opening 6 (in FIG. 1, the upper end portion) when projected in the extrusion direction.

The conveyer 8 has a driving roller 9, a driven roller 10, and an endless belt 11. The driving roller 9 is disposed between the die 5 and the cutter 7 in the extrusion direction, at a lower side of the die 5. The driven roller 10 is disposed at a downstream side of the driving roller 9 in a horizontal direction. The endless belt 11 is wound around the driving roller 9 and the driven roller 10. In the conveyer 8, the driven roller 10 is driven by driving of the driving roller 9, and the endless belt 11 runs around the driving roller 9 and the driven roller 10. To be specific, the upper face of the endless belt 11 moves from the upstream side towards the downstream side in the extrusion direction.

Then, to mold the heat-foamable material by extrusion molding, the heat-foamable material is introduced into the hopper 3.

The heat-foamable material introduced into the hopper 3 is heated by the cylinder 4, and while being melt-kneaded by the screw, the heat-foamable material is extruded cylindrically from the discharge opening 6 of the die 5, thereby being molded as a cylindrical molded product 12 (extrusion step).

In this extrusion step, the distance from the cylinder 4 to the discharge opening 6 having a hoop shape is equal at any point, and therefore there is substantially no difference in the flow of the heat-foamable material being extruded. Thus, based on the hoop-shaped discharge opening 6, any portion of which being an isotropic portion, the heat-foamable material is extruded in the extrusion direction so as to have isotropic characteristics.

In the extrusion step, the temperature of the cylinder 4 is, for example, 40 to 110° C., or preferably 60 to 100° C. The temperature of the die 5 is, for example, 60 to 110° C., or preferably 80 to 100° C. The extrusion speed of the heat-foamable material is, for example, 0.5 to 2.0 m/minute, or preferably 0.7 to 1.7 m/minute.

Then, the extruded cylindrical molded product 12 is received by the endless belt 11 of the conveyer 8, and while being transported by the endless belt 11, the upper end portion of the extruded cylindrical molded product 12 is continuously cut along the extrusion direction with the cutter 7.

Thus, by cutting the cylindrical molded product 12 at the upper end portion of the cross sectional hoop, the cylindrical molded product 12 is symmetrically opened from its upper end portion without being extended in the circumferential direction (so as to have isotropic characteristics in the widthwise direction), thereby formed as a sheet-shaped molded product 13 (sheet-forming step).

In the sheet-forming step, the transportation speed of the conveyer 8 is, for example, 0.5 to 2.0 m/minute, or preferably 0.7 to 1.7 m/minute. The transportation speed of the conveyer 8 is set to substantially the same speed as that of the extrusion speed.

The heat-foamable sheet 14 thus can be obtained as the sheet-shaped molded product 13. That is, the heat-foamable sheet 14 is extruded from the discharge opening 6 having a hoop shape that is an isotropic portion, and molded into the cylindrical molded product 12 that has isotropic characteristics in the longitudinal direction. Then, the cylindrical molded product 12 is formed into a sheet shape by the cutter 7, whereby the heat-foamable sheet 14 is formed as the sheet-shaped molded product 13 that has isotropic characteristics in the circumferential direction (the widthwise direction in the form of the sheet shape).

Therefore, the obtained heat-foamable sheet 14 has omnidirectional isotropic characteristics, and changes in the horizontal to vertical ratio are decreased even if the sheet is heated and foamed (that is, the heat-foamable sheet 14 can be foamed in its horizontal plane while keeping the similar shape). To be specific, the obtained heat-foamable sheet 14 has a horizontal to vertical ratio of, when heated at 160° C. for 20 minutes, 1.5 or less, preferably 1.35 or less, or more preferably 1.15 or less.

As a result, when the heat-foamable sheet 14 is punch-processed into an end product, a yield at the time of the punch-processing can be improved without particularly considering directional properties. Furthermore, design efficiency of the final shape can also be improved.

According to the above-described method, the heat-foamable sheet 14 that has isotropic characteristics can be easily produced with good production efficiency.

When the horizontal to vertical ratio exceeds 1.5, the directional properties have to be considered when punching into a final shape, and therefore production efficiency decreases.

The horizontal to vertical ratio is measured according to the following procedures. First, the heat-foamable sheet 14 is cut out to give a generally rectangular shape to be used as a test piece, and the length (La) of a side of the test piece (in the following, referred to as side a), and the length (Lb) of another side that forms a right angle with side a (in the following, referred to as side b) are measured.

Then, the test piece is heated at 160° C. for 20 minutes, and the length (La′) of side a after heating, and the length (Lb′) of side b after heating are measured. Then, the extension ratios of side a and side b are calculated using the formula below.

Extension ratio of side a=La′/La

Extension ratio of side b=Lb′/Lb

Then, the horizontal to vertical ratio is calculated by comparing the extension ratio of side a and the extension ratio of side b, and dividing the larger extension ratio by the smaller extension ratio. That is, when the extension ratio of side a is larger than the extension ratio of side b, the horizontal to vertical ratio is calculated by the following formula.

Horizontal to vertical ratio=(La′/La)/(Lb′/Lb)

The horizontal to vertical ratio can be easily calculated by cutting out the test piece into a square shape (e.g., 50 mm×50 mm).

The thickness of the heat-foamable sheet 14 is, for example, 1 to 5 mm, or preferably 2 to 4 mm.

In the above-described method, the transportation speed of the conveyer 8 is set to substantially the same as the extrusion speed of the extruder 1. Therefore, when the sheet-shaped molded product 13 is formed from the cylindrical molded product 12 as well, the stretching force and compressing force in the extrusion direction are not imposed, and as a result, the isotropic characteristics can be improved.

Although the extrusion step and the sheet-forming step are carried out sequentially in the above-described method, these extrusion step and sheet-forming step can also be performed simultaneously.

To simultaneously perform the extrusion step and the sheet-forming step, for example, in the extruder 1, a die 5 in which a discharge opening 6 having a partially cutaway hoop shape (generally C-shaped) is formed as shown in FIG. 2(b) is provided instead of the die 5 in which a discharge opening 6 having a hoop shape as shown in FIG. 2(a) is formed. That is, in the discharge opening 6 shown in FIG. 2(b), a discontinuous portion 15 that crosses in the diameter direction at the upper end portion of the hoop shape is provided. That is, the discharge opening 6 is formed as an arc portion 16 having ends at the portion divided by the discontinuous portion 15.

The discharge opening 6 shown in FIG. 2(b) is formed to have the same size as that of the discharge opening 6 shown in FIG. 2(a), except that the discontinuous portion 15 is provided. The length of the discontinuous portion 15 in the circumferential direction is, for example, 0.5 to 10 mm, or preferably 1 to 3 mm.

Then, by molding the heat-foamable material by extrusion using the extruder 1 equipped with the die 5 shown in FIG. 2(b), the heat-foamable material is continuously extruded from the arc portion 16 that is an isotropic portion of the discharge opening 6, while the extrusion of the heat-foamable material is prevented at the discontinuous portion 15. Thus, the heat-foamable material is symmetrically opened from the discontinuous portion 15, and molded directly into a sheet shape.

Therefore, the obtained heat-foamable sheet 14 has isotropic characteristics omnidirectionally as the above-described one. To be specific, the sheet has a horizontal to vertical ratio when heated at 160° C. for 20 minutes of, 1.5 or less, preferably 1.35 or less, or more preferably 1.15 or less.

Furthermore, a die 5 in which a discharge opening 6 having a horseshoe shape (generally U-shaped) as shown in FIG. 2(c) is formed can also be provided in the extruder 1 instead of the die 5 shown in FIG. 2(a). That is, the discharge opening 6 shown in FIG. 2(c) is provided with a semi-arc portion 17 that is opened towards above; and linear portions 18 that extend towards above continuously and linearly from both end portions of the semi-arc portion 17, and have upper end portions.

The semi-arc portion 17 of the discharge opening 6 shown in FIG. 2(c) is formed to have the same size as that of the corresponding part of the discharge opening 6 shown in FIG. 2(a).

Then, by molding the heat-foamable material by extrusion using the extruder 1 equipped with the die 5 shown in FIG. 2(c), the heat-foamable material is continuously extruded from the semi-arc portion 17 that is an isotropic portion of the discharge opening 6, and the linear portion 18. Thus, the heat-foamable material is symmetrically opened from the linear portion 18, and molded directly into a sheet shape.

Therefore, the obtained heat-foamable sheet 14 has isotropic characteristics omnidirectionally at the portion extruded from the semi-arc portion 17. To be specific, the sheet has a horizontal to vertical ratio when heated at 160° C. for 20 minutes of, 1.5 or less, preferably 1.35 or less, or more preferably 1.15 or less.

The portion extruded from the linear portion 18 is anisotropic compared with the portion extruded from the semi-arc portion 17, because the flow of the heat-foamable material differs depending on the portion. However, because the difference between the distance from the cylinder 4 to the linear portion 18, and the distance from the cylinder 4 to the semi-arc portion 17 is small, even the portion extruded from the linear portion 18 has a horizontal to vertical ratio when heated at 160° C. for 20 minutes of, 1.5 or less, and the sheet can be used as the heat-foamable sheet of the present invention.

The heat-foamable sheet 14 obtained by the above-described method has, as described above, isotropic characteristics, and therefore when the sheet is heated under appropriate conditions, the sheet is foamed omnidirectionally and uniformly, which enables uniform filling of a space.

The foam formed by foaming has a density (foam weight (g)/foam volume (cm³)) of, for example, 0.03 to 0.3 g/cm³, or preferably 0.05 to 0.1 g/cm³, and a foaming ratio by volume when foamed of, 3 times or more, or preferably 10 to 20 times.

Furthermore, because the heat-foamable sheet 14 can fill a space uniformly by omnidirectionally foaming, the sheet can be used as a filler of various industrial products, for example, as a vibration-damping material, a sound insulating material, a dust prevention material, a heat insulation material, a shock absorbing material, a water shutoff material and the like that fill in between various members or the inner space of a hollow member, without any particular limitation, for the purposes of vibration-damping, sound insulation, dust prevention, heat insulation, shock absorption, watertight processing, etc.

To be specific, for example, when an inner space of a hollow member is to be filled, first, a fixing member is attached to the heat-foamable sheet 14 to prepare a foam filling member, and after the fixing member of the foam filling member is attached to the inner space of the hollow member, the sheet is foamed by heating, thereby forming a foam, so that the inner space of the hollow member can be uniformly filled by the foam.

An automobile pillar is an example of such a hollow member, and by preparing a foam filling member from the heat-foamable sheet 14, attaching the member to the inner space of the pillar, and foaming the member, the foam achieves sufficient reinforcement for the pillar, and effectively prevents vibration or noise of an engine, or wind noise from being propagated into car interior.

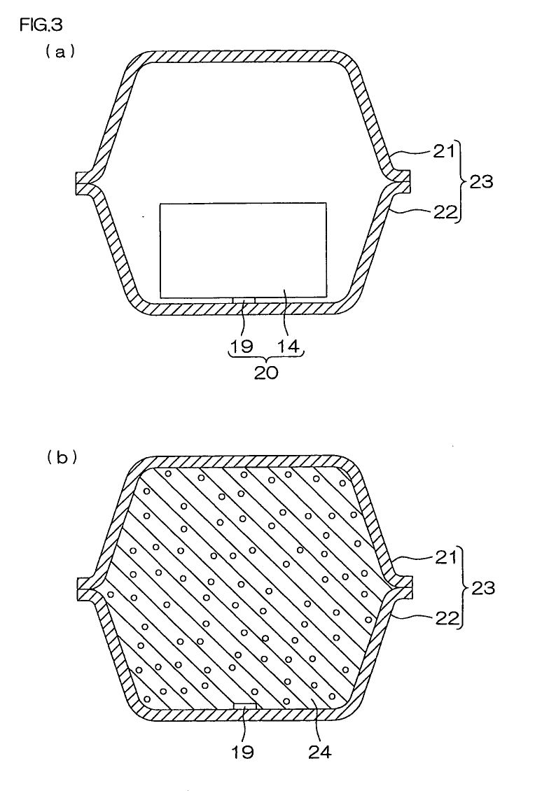

FIG. 3 shows process drawings of an embodiment of a method for filling an inner space of a pillar using the foam filling member. Next, referring to FIG. 3, a description will be given of a method for filling an inner space of the pillar 23 by heating and foaming the foam filling member 20 provided with the heat-foamable sheet 14. As shown in FIG. 3, the foam filling member 20 includes the heat-foamable sheet 14, and a clip 19 attached to the heat-foamable sheet 14 to serve as a fixing member capable of fixing the heat-foamable sheet 14 in the inner space of the pillar 23 as a hollow member.

The clip 19 is made of a hard resin, and is molded, for example, by injection molding. The foam filling member 20 is prepared by fitting the clip 19 into the heat-foamable sheet 14 that is cut out into an appropriate shape by processing such as punching in accordance with the hollow space of the pillar 23. The pillar 23 is made up of an inner panel 22 and an outer panel 21 that have a generally concave cross section.

In this method, first, the foam filling member 20 is placed in the inner panel 22. Then, both end portions of the inner panel 22 and the outer panel 21 are brought into contact with each other so that the both end portions face each other, and are joined together by welding. The pillar 23 is thus formed as a closed cross section. Such a pillar 23 is used, to be specific, as a front pillar, a side pillar, or a rear pillar of a vehicle body.

Afterwards, in this method, the inner surface of the pillar 23 is subjected to a rust-proof treatment, and then, for example, by heating (for example, at 150 to 215° C.) in a drying line process at the time of baking finish after the treatment, the heat-foamable sheet 14 is foamed. Thus, the heat-foamable sheet 14 is omnidirectionally and uniformly foamed to form the foam 24, and the foam 24 uniformly fills the inner space of the pillar 23 without gaps.

That is, in the method for filling a hollow space of the pillar 23, the heat-foamable sheet 14 extends omnidirectionally by heat, and therefore the filling can be achieved easily and at a low-cost without gaps.

Also, although the foam filling member 20 is provided with the heat-foamable sheet 14 and the clip 19 in the above description, the foam filling member 20 of the present invention is not limited thereto, and, for example, may be made only from the heat-foamable sheet 14 without attaching the clip 19.

### EXAMPLES

### Example 1

As a polymer, 100 parts by weight of an ethylene-vinyl acetate copolymer (EVAFLEX EV460, melting point 84° C., MFR 2.5, vinyl acetate content 19%, manufactured by Du PONT-MISUI POLYCHEMICALS CO., LTD.) was kneaded at 90° C. for 5 minutes using a pressure kneader, at 20 rpm. Then, 5 parts by weight of dicumyl peroxide (PERCUMYL D-40MBK, dicumyl peroxide content 40%, silica and EPDM content 60%, manufactured by NOF Corporation) as a cross-linking agent, 20 parts by weight of 4,4′-oxybis(benzene sulfonyl hydrazide)(Cellmic SX, decomposition temperature 160° C., manufactured by SANKYO KASEI CO., LTD.) as a foaming agent, and 1 part by weight of stearic acid as a lubricant were mixed, and the mixture was kneaded at 90° C. for 5 minutes, thereby preparing a heat-foamable material.

Then, the heat-foamable material was molded by extrusion using the extruder 1 shown in FIG. 1 equipped with the die 5 in which the discharge opening 6 (inner diameter ID 48 mm, outer diameter OD 50 mm, space S 2 mm) having a hoop shape as shown in FIG. 2(a) was formed, under the molding conditions shown in Table 1. Thereafter, the molded product was continuously cut with the cutter 7, thereby preparing a heat-foamable sheet 14 having a thickness of 2 mm.

### Examples 2 to 4 and Comparative Example 1

A heat-foamable sheet 14 was prepared in the same manner as in Example 1, except that the molding conditions shown in Table 1 were used.

### Comparative Example 2

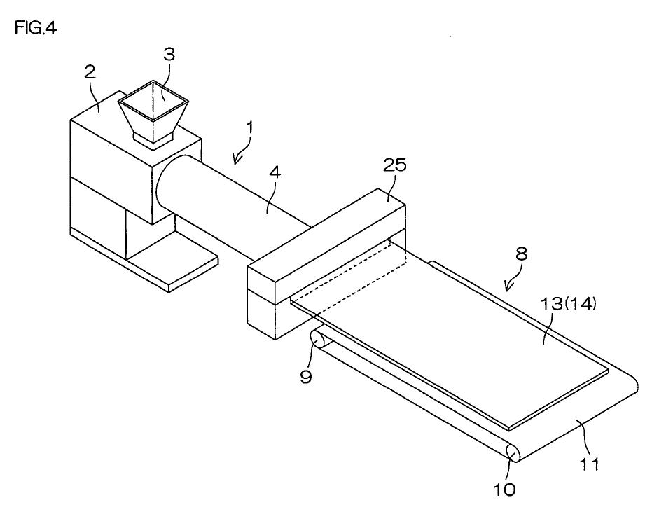

A heat-foamable sheet 14 was prepared in the same manner as in Example 1, except that an extruder 1 equipped with a T die 25 shown in FIG. 4 in which a discharge opening having a flat rectangular shape was formed was used instead of the die 5 shown in FIG. 2(a) and the molding conditions shown in Table 1 were used.

### Comparative Example 3

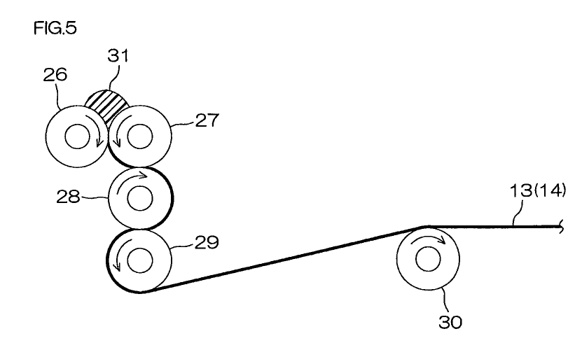

A heat-foamable sheet 14 was prepared in the same manner as in Example 1, except that a calender roll apparatus shown in FIG. 5 was used instead of the extruder 1 shown in FIG. 1 and the rolling conditions (surface temperature of the calender roll and the revolution speed of the calender roll) shown in Table 2 were used for rolling and molding.

That is, with reference to FIG. 5, a heat-foamable material 31 was first introduced from above a nip portion of a first calender roll 26 and a second calender roll 27. The heat-foamable material 31 was rolled between the first calender roll 26 and the second calender roll 27, transferred to the surface of the second calender roll 27, rolled between the second calender roll 27 and a third calender roll 28, transferred on the surface of the third calender roll 28, rolled between the third calender roll 28 and a fourth calender roll 29, and transferred to the surface of the fourth calender roll 29.

Thereafter, the heat-foamable material 31 was received by a receiving roll 30 from the fourth calender roll 29, as a heat-foamable sheet 14.

TABLE 1

| | Extruder | | | Conveyer |
|---|---|---|---|---|
| | Cylinder | Die | Extrusion | Transportation |
| | Temperature | Temperature | Speed | Speed |
| | (° C.) | (° C.) | (m/minute) | (m/minute) |
| Example 1 | 90 | 90 | 2 | 2 |
| Example 2 | 90 | 90 | 3 | 3 |
| Example 3 | 90 | 90 | 5 | 5 |
| Example 4 | 90 | 90 | 3 | 4 |
| Comp. Ex. 1 | 90 | 90 | 2 | 4 |
| Comp. Ex. 2 | 90 | 90 | 3 | 3 |

TABLE 2

| | | Comparative |
|---|---|---|
| | | Example 3 |
| Calender Roll Temperature.° C. | First Calender Roll | 87 |
| | Second Calender Roll | 88 |
| | Third Calender Roll | 88 |
| | Fourth Calender Roll | 87 |
| Calender Roll Speed.m/minute. | First Calender Roll | 2.5 |
| | Second Calender Roll | 2.7 |
| | Third Calender Roll | 3 |
| | Fourth Calender Roll | 3 |

| | |
|---|---|
| Receiving Speed.m/minute. | 3 |

### (Evaluation of Heat-Foamable Sheet)

The obtained heat-foamable sheet was cut out into a square of 50 mm×50 mm from its center portion and end portion, thereby obtaining test pieces. These test pieces were heated at 160° C. for 20 minutes and foamed, and their horizontal to vertical ratios were calculated. The results of the horizontal to vertical ratio at the center portion, and the end portion are shown in Table 3. The foaming ratio is also noted in Table 3.

TABLE 3

| | |
|---|---|
| Horizontal To | |
| Vertical Ratio | Foaming |

| | Center | End | Ratio |
|---|---|---|---|
| | Portion | Portion | (Times) |
| Example 1 | 1.05 | 1.05 | 16 |
| Example 2 | 1.05 | 1.05 | 16 |
| Example 3 | 1.10 | 1.01 | 16 |
| Example 4 | 1.30 | 1.35 | 16 |
| Comp. Ex. 1 | 1.90 | 1.95 | 16 |
| Comp. Ex. 2 | 1.12 | 1.80 | 16 |
| Comp. Ex. 3 | 2.43 | 2.51 | 16 |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

A heat-foamable sheet and a foam filling member of the present invention that are produced by the producing method according to the present invention can be used as a filler for various industrial products.

1. A heat-foamable sheet molded by subjecting a heat-foamable material containing a polymer and a foaming agent to extrusion molding, wherein the heat-foamable sheet has a horizontal to vertical ratio of 1.5 or less when heated at 160° C. for 20 minutes.

2. A heat-foamable sheet that has isotropic characteristics.

3. A method for producing a heat-foamable sheet, the method comprising the steps of:
an extrusion step of extruding a heat-foamable material containing a polymer and a foaming agent into an isotropy-containing shape including an isotropic portion of generally an arc shape; and
a sheet-forming step of forming the heat-foamable material that is extruded in the extrusion step into a sheet shape.

4. The method for producing a heat-foamable sheet according to claim 3,
wherein in the extrusion step, a cylindrical molded product is obtained by extruding the heat-foamable material into a cylindrical shape with an extruder equipped with a die having a discharge opening of a hoop shape; and
in the sheet-forming step, a sheet-shaped molded product is obtained by continuously cutting the cylindrical molded product in the extrusion direction with a cutter, wherein the cutter is disposed at a downstream side of the discharge opening in the extrusion direction so as to overlap with a portion of the discharge opening when the cutter is projected in the extrusion direction.

5. The method for producing a heat-foamable sheet according to claim 3, wherein the extrusion step and the sheet-forming step are simultaneously performed by extruding the heat-foamable material with an extruder equipped with a die having a discharge opening having an end-portion-including shape including a generally arc portion.

6. The method for producing a heat-foamable sheet according to claim 3, wherein the heat-foamable material that is formed into a sheet shape is transported by a conveyer having a speed that is substantially the same as the extrusion speed in the extrusion step.

7. A foam filling member comprising:
a heat-foamable sheet molded by subjecting a heat-foamable material containing a polymer and a foaming agent to extrusion molding, wherein the heat-foamable sheet has a horizontal to vertical ratio of 1.5 or less when heated at 160° C. for 20 minutes; and
a fixing member that is attached to the heat-foamable sheet and is fixable to an inner space of a hollow member.
